(19) United States
(12) Patent Application Publication
(10) Pub. No.: US 2002/0053654 A1
(43) Pub. Date: May 9, 2002

(54) Magnetic core for xDSL modem transformer and its composition

(75) Inventors: Yuji Sezai, Tokyo (JP); Ippou Hirai, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 09/944,590

(22) Filed: Sep. 4, 2001

(30) Foreign Application Priority Data
Sep. 14, 2000 (JP) 2000-279101

(51) Int. Cl. C04B 35/26

(52) U.S. Cl. 252/62.56

(57) ABSTRACT

A magnetic core composition for an xDSL modem transformer having a main component comprised of MnO: 22.0 to 34.5 mol % and ZnO: 12.0 to 25.0 mol % and the rest of substantially Fe₂O₃. With a magnetic core for a transformer made of this composition, the THD of the transformer becomes not more than −80 dB in a broad frequency band, so this can be used advantageously as the magnetic core for an xDSL modem transformer.

### BACKGROUND OF THE INVENTION

1. Field of the Invention

The present invention relates to a magnetic core of a transformer used in a high speed data communications modem in a digital subscriber line such as an asymmetric digital subscriber line (ADSL) or VDSL (in general called an “xDSL”) and a composition of the same, more particularly relates to an Mn-Zn-based ferrite magnetic core for a transformer with a superior total harmonic distortion (THD) of the transmission waveform at the time of data communication in a broad frequency band and a composition of the same.

2. Description of the Related Art

In recent years, in the field of electronics, equipment has been required to be made smaller in size, smaller in thickness, and improved in performance. Further, in the field of communications equipment, the impedance of the -primary coil in the pulse transformer for interfacing with the Integrated Services Digital Network (ISDN) etc. has to be increased in a broad frequency band to improve the transmission characteristics. Therefore, the primary coil is required to have a high inductance. The I.430 and other standards of the ITU (International Telecommunications Union)-T required that at least 20 mH be secured for the inductance of the primary coil of the pulse transformer.

Further, to reduce the size and thickness of electronic equipment in this way, the transformer has to be made smaller and thinner. Therefore, the necessary inductance is being secured by increasing the magnetic permeability of the material of the magnetic core used for the transformer (Japanese Unexamined Patent Publication (Kokai) No. 6-263447, Japanese Unexamined Patent Publication (Kokai) No. 7-94314, Japanese Unexamined Patent Publication (Kokai) No. 7-169612, Japanese Unexamined Patent Publication (Kokai) No. 7-211530, Japanese Unexamined Patent Publication (Kokai) No. 7-278764, Japanese Unexamined Patent Publication (Kokai) No. 7-297034, Japanese Unexamined Patent Publication (Kokai) No. 8-85821, Japanese Unexamined Patent Publication (Kokai) No. 8-97045, Japanese Unexamined Patent Publication (Kokai) No. 9-246034, Japanese Unexamined Patent Publication (Kokai) No. 10-12447, and Japanese Unexamined Patent Publication (Kokai) No. 10-335130), reducing the thickness of the transformer (Japanese Unexamined Patent Publication (Kokai) No. 7-201582, Japanese Unexamined Patent Publication (Kokai) No. 7-201585, Japanese Unexamined Patent Publication (Kokai) No. 7-201588, Japanese Unexamined Patent Publication (Kokai) No. 7-201589, and Japanese Unexamined Patent Publication (Kokai) No. 7-201590), mirror-polishing the bonding surfaces in the case of a split-type magnetic core such as an EE shape (Japanese Unexamined Patent Publication (Kokai) No. 9-246034), etc.

Even in a transformer of a modem used for connecting a telephone line transmitting an analog signal and a data terminal or computer handling a digital signal, a similarly high inductance is required (Japanese Unexamined Patent Publication (Kokai) No. 11-176643 and Japanese Unexamined Patent Publication (Kokai) No. 11-186044).

Due to the rapid spread of the Internet, however, demand has risen for communication systems enabling higher speed communication of large quantities of data compared with the prior art. New communication systems such as ADSL have been developed. ADSL requires a modem for converting between a digital signal and analog signal.

ADSL technology has a much higher transmission speed than in the past, that is, 16 to 640 kb/s for uplink signals and 1.5 to 9 Mb/s for downlink signals. The operating frequency band is also a high one of 30 kHz to 1.1 MHz. Therefore, the transformer used for a modem may be reduced in the inductance for raising the impedance compared with the conventional transformers. Accordingly, the magnetic permeability of the material of the magnetic core of the transformer may be made smaller than that in the past and mirror-polishing of the bonding surfaces is not required even in the case of a split-type magnetic core such as an EE shape.

On the other hand, in high speed data communications using such ADSL, the transformer used in the modem for transmitting a data signal at a high speed has to have a small distortion of the transmission waveform and noise and has to be reduced in the rate of occurrence of transmission error, so a material of the magnetic core having a small THD is sought.

Therefore, the loss in the AC magnetic field such as the eddy current loss, the hysteresis loss, and the residual loss has to be reduced.

Note that the THD means the ratio of the total harmonics and the noise component with respect to the basic signal of the input data at the time of data communication as expressed by the following equation (1), so the THD becomes smaller the smaller the distortion of the transmission waveform or noise.

THD(dB)=20log (harmonics+noise)/(basic wave+harmonics+noise) (1)

### SUMMARY OF THE INVENTION

An object of the present invention is to provide a magnetic core for a high performance xDSL modem transformer suitable for use as a magnetic core for a transformer of a modem used in ADSL or other high speed data communication and superior in THD characteristic in a broad frequency band and its composition.

To attain the above object, according to the present invention, there is provided a magnetic core composition for an xDSL modem transformer having a main component comprised of MnO: 22.0 to 34.5 mol %, ZnO: 12.0 to 25.0 mol %, and the rest of substantially Fe 203

In the present invention, the magnetic core composition preferably has a main component comprised of MnO: 23 to 33 mol %, ZnO: 13 to 24 mol %, and the rest of substantially Fe₂O₃.

With a magnetic core for an xDSL modem transformer comprised of the magnetic core composition for a transformer according to the present invention, the THD characteristic of the transformer becomes not more than −80 dB in a broad frequency band. Therefore, the distortion of the transmission waveform and noise in high speed data communication become smaller, the occurrence of transmission error can be prevented, and a data signal can be transmitted at a high accuracy.

Note that THD is defined by the above equation (1).

In the present invention, if the ratio of MnO in the main component of the magnetic core for a transformer becomes larger than 34.5 mol % or the ratio of ZnO becomes smaller than 12.0 mol %, the loss of the magnetic core material in an AC magnetic field tends to become larger and the THD to become higher.

If the ratio of MnO becomes smaller than 22.0 mol % or the ratio of ZnO becomes larger than 25.0 mol %, the Curie point of the magnetic core composition falls to the region of the temperature of actual use and the characteristic as ferrite is lost.

Particularly, in the present invention, the magnetic core composition preferably has a main component comprised of MnO: 23.8 to 24.2 mol %, ZnO: 23.0 to 23.4 mol %, and Fe₂O₃: 52.6 to 53.0 mol %.

In the case of this range of composition, the THD characteristic of the transformer can be made not more than −85 dB in a broad frequency band. Therefore, it is possible to further reduce the distortion of the transmission waveform or noise in high speed data communications, possible to further prevent occurrence of transmission error, and possible to transmit a data signal at a higher accuracy.

Alternatively, the magnetic core composition preferably has a main component comprised of MnO: 26.1 to 26.5 mol %, ZnO: 20.1 to 20.5 mol %, and Fe₂O₃: 53.2 to 53.6 mol %.

In the case of this range of composition as well, the THD characteristic of the transformer can be made not more than −85 dB in a broad frequency band. Therefore, it is possible to further reduce the distortion of the transmission waveform or noise in high speed data communications, possible to further prevent occurrence of transmission error, and possible to transmit the data signal at a higher accuracy.

Alternatively, the magnetic core composition has a main component comprised of MnO: 23.0 to 23.4 mol %, ZnO: 23.4 to 23.8 mol %, and Fe₂O₃: 53.0 to 53.4 mol %.

In the case of this range of composition, the THD characteristic of the transformer can be made not more than −80 dB over a broad temperature range of −40 to +85° C. and in a broad frequency band. Therefore, even in an atmosphere with sharp changes in temperature, it is possible to further reduce the distortion of the transmission waveform or noise in xDSL or other high speed data communications, possible to further prevent occurrence of transmission error, and possible to transmit the data signal at a higher precision.

The transformer magnetic core composition of the present invention is suitably used as a magnetic core material for an XDSL modem transformer.

According to a first aspect of the present invention, there is provided a magnetic core of an XDSL modem transformer comprised of the above magnetic core composition.

According to a second aspect of the present invention, there is provided a magnetic core for a transformer comprising a bottom plate, a columnar center leg rising from an approximate center of the bottom plate in a first direction, and an outer leg rising from the bottom plate surrounding at least the two sides of the center leg in the first direction separated by a predetermined space, a height of the center leg being lower than a height of the outer leg by exactly a predetermined gap and a through gap of substantially the same height as the height of the center leg being formed at part of the top of the outer leg.

The magnetic core for a transformer according to the second aspect of the present invention is preferably comprised of the above magnetic core composition for a transformer.

In the magnetic core for a transformer according to the second aspect of the present invention, the height of the center leg of the magnetic core and the height of part of the outer leg are made the same, so it is possible to grind the center leg and that part of the outer leg simultaneously by the same grinding step. Therefore, it is possible to align a plurality of materials for magnetic cores for transformers together and continuously grind the tops of the center legs and those parts of the outer legs and therefore possible to perform the grinding efficiently.

Note that even if the through gap is provided at part of the outer leg in this way, in a magnetic core for a transformer comprised by the transformer magnetic core composition of the present invention, the THD of the transformer in the broad frequency band can be made not more than −75 dB.

### BRIEF DESCRIPTION OF THE DRAWINGS

These and other objects and features of the present invention will become clearer from the following description of the preferred embodiments given with reference to the attached drawings, wherein:

FIG. 1A is a perspective view of the shape of a magnetic core measured for THD;

FIG. 1B is a front view of the magnetic core shown in FIG. 1A;

FIG. 2 is a circuit diagram of THD measurement;

FIG. 3 is a graph of the broad frequency band characteristic of THD;

FIG. 4 is a a graph of an example of the measurement value when giving temperature changes;

FIG. 5A is a perspective view of a modification of the magnetic core shown in FIG. 1A and FIG. 1B;

FIG. 5B is a front view of the magnetic core shown in FIG. 5A;

FIG. 6A is a plan view of a magnetic core of an RM shape;

FIG. 6B is a perspective view of the magnetic core shown in FIG. 6A;

FIG. 7A is a plan view of a magnetic core of a pot shape;

FIG. 7B is a sectional view of the magnetic core shown in FIG. 7A; and

FIG. 8 is a perspective view of a magnetic core of an EPC shape.

### DESCRIPTION OF THE PREFERRED EMBODIMENTS

First Embodiment

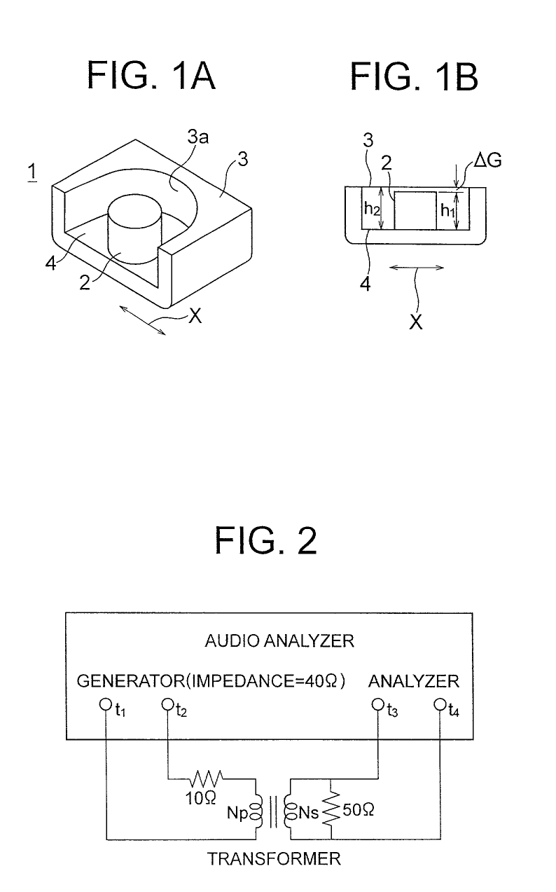

As shown in FIG. 1A and FIG. 1B, the magnetic core 1 for an XDSL modem transformer according to a first embodiment of the present invention is a magnetic core of a so-called “EP shape”. It has a center leg 2, an outer leg 3, and a bottom plate 4. These are formed integrally. The center leg 2 rises from the approximate center of the bottom plate 4 in the X-direction (first direction) and has a cylindrical shape. The outer leg 3 rises from the bottom plate 4 so as to surround at least the two sides of the center leg 2 in the X-direction separated by a predetermined space. In the present embodiment, an arc-shaped recessed inner wall 3a substantially concentric with the center leg 2 is formed at the outer leg 3.

Usually two magnetic cores 1 are used. They are used with one magnetic core 1 superposed on the other magnetic core 1 turned around and with the center legs 2 and outer legs 3 superposed respectively. At this time, the center legs 2 are inserted into bobbins around which the primary coil and secondary coil are wound. To adjust the inductance to a suitable value, a gap AG is provided at the tops of the center legs 2 of the magnetic core 1.

That is, when a gap ΔG is necessary, at least one magnetic core 1 has a relationship of h₂=h₁+ΔG of a height h₁ from the bottom plate 4 of the center leg 2 and the height h₂ from the bottom plate 4 of the outer leg 3. When two magnetic cores 1 are used superposed, there is at least a gap ΔG.

In order to reduce the leakage inductance, the primary coil was divided into two to form a sandwich coil of a primary coil (70 turns)-secondary coil (140 turns)-primary coil (70 turns).

The magnetic core 1 for an XDSL modem transformer of the present embodiment shown in FIG. 1A and FIG. 1B is produced for example as shown below.

As the starting materials of the main component, Fe₂O₃, Mn₃O₄, and ZnO are used. Further, as the sub components, at least two of the following are contained: SiO₂:30 to 180 ppm, CaCO₃: 100 to 2000 ppm, Nb₂O₅: 0 to 300 ppm, V₂O₅: 0 to 500 ppm, MoO₃: 0 to 400 ppm, ZrO: 0 to 300 ppm, Bi₂O₃: 0 to 800 ppm, SnO₂: 0 to 3500 ppm, and P: 0 to 100 ppm.

In the present invention, the starting materials are weighed so that the composition of the main component after firing becomes MnO: 22.0 to 34.5 mol %, ZnO: 12.0 to 25.0 mol %, and the rest of substantially Fe₂O₃. These are wet mixed, then dried and calcined in the atmosphere for 2 hours at 900° C.

Next, the sub components are added to the obtained calcined material and mixed by pulverization. After mixing, a suitable binder, for example, polyvinyl alcohol, is added, the result is granulated by a spray drier etc., then the EP shape is formed. The obtained shaped article is fired at 1400° C. in an atmosphere controlled in oxygen concentration to obtain a magnetic core 1 for a transformer comprised of an Mn—Zn-based ferrite sintered body as shown in FIG. 1A and FIG. 1B.

The magnetic core 1 according to the present embodiment has a composition of the main component containing MnO: 22.0 to 34.5 mol %, ZnO: 12.0 to 25.0 mol %, and the rest of substantially Fe₂O₃. Therefore, a transformer using the magnetic core 1 has a small loss in an AC magnetic field and, as a result, the THD of the transformer becomes a small value of not more than −80 dB in a broad frequency band. Therefore, when performing high speed data communication such as with ADSL by a modem using the ferrite magnetic core 1 in its transformer, the distortion of the transmission waveform or noise in the transformer becomes small and occurrence of transmission error can be prevented, so data can be transmitted with a high accuracy.

Second Embodiment

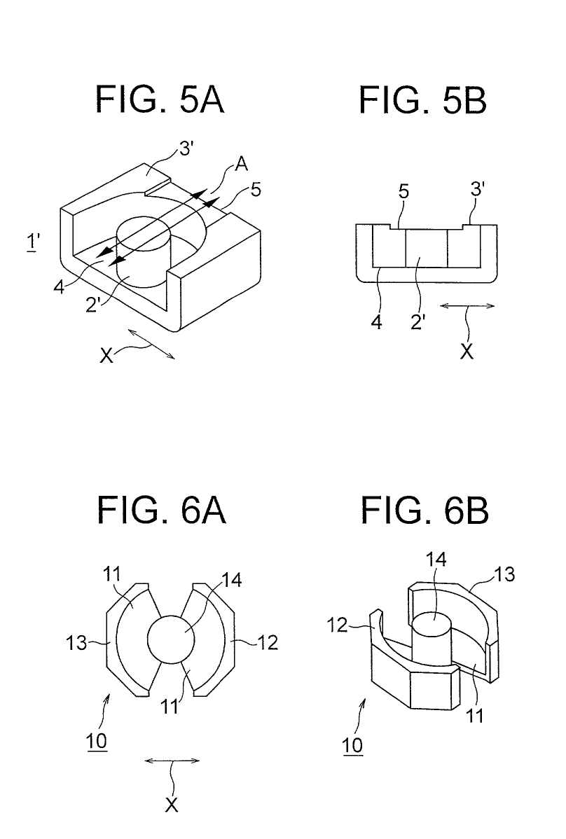

As shown in FIG. 5A and FIG. 5B, the magnetic core 1′ for a transformer according to the second embodiment of the present invention is a modification of the magnetic core 1 for a transformer according to the first embodiment and is the same in composition of the main component. In the magnetic core 1′ for a transformer, a through gap 5 of substantially the same height as the height of the center leg 2′ is formed at part of the top of the outer leg 3′. The width of the through gap 5 is made larger than the outside diameter of the center leg 3′.

This through gap 5 is formed by making a grinding pad of a grinding apparatus move horizontally to the outer leg 3′ as shown by the arrow A of FIG. 5A when grinding the top of the center leg 2′ by a grinding apparatus to form a gap ΔG shown in FIG. 1B.

In the magnetic core 1′ for a transformer of the present embodiment, since the height of the center leg 2′ of the magnetic core 1′ and the height of the through gap 5 of the outer leg 3′ are made the same, it is possible to simultaneously grind the center leg 2′ and the through gap 5 of the outer leg 3′ by the same grinding step. That is, by aligning a plurality of magnetic core materials in the arrow direction A and grinding while moving the grinding pad from the center legs 2′ to the outer legs 3′ as shown by the arrow A, it becomes possible to simultaneously process a large number of magnetic cores by a single grinding step and therefore process the gaps of the magnetic cores with a good mass productivity.

Note that even if providing the through gap 5 at part of the outer leg 3′ in this way, in the magnetic core 1′ for a transformer made from the transformer magnetic core composition of the present invention, the THD of the transformer in the broad frequency band only becomes higher by about 2 dB compared with a magnetic core 1 of a center gap shown in FIG. 1A and FIG. 1B. Therefore, with the magnetic core 1′ for a transformer, the THD of the transformer can be made not more than −75 dB in a broad frequency band.

Therefore, when using a transformer using the magnetic core 1′ of a through gap structure for a modem in ADSL or other high speed data communication, the distortion of the transmission waveform or noise in the transformer becomes small and occurrence of transmission error can be prevented, so data can be transmitted with a high accuracy.

This through gap can be applied not only to an EP shape, but also a later mentioned RM shape, pot shape, EPC shape, etc.

Third Embodiment

As shown in FIG. 6A and FIG. 6B, the magnetic core for a transformer according to the third embodiment of the present invention is the same in composition of the main component as the magnetic core 1 for a transformer according to the first embodiment and differs only in the shape.

As shown in FIG. 6A and FIG. 6B, the magnetic core 10 is a magnetic core of a so-called “RM shape” and is provided with a disk (bottom plate) 11, a ring (outer leg) 12 and 13 formed integrally with the peripheral edges, and a slug (center leg) 14 formed at the center of the disk 11.

Even with the magnetic core 10 for a transformer according to this embodiment, it is possible to make the THD of the transformer not more than −75 dB over a broad frequency band.

When using a transformer using a magnetic core 10 for a modem in ADSL or other high speed data communication, the distortion of the transmission waveform or noise in the transformer becomes small and occurrence of transmission error can be prevented, so data can be transmitted with a high accuracy.

Fourth Embodiment

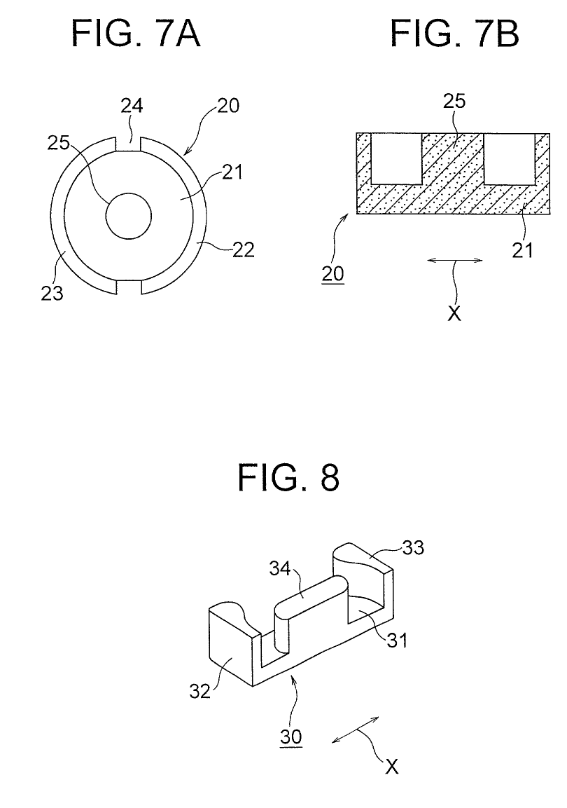

As shown in FIG. 7A and FIG. 7B, the magnetic core for a transformer according to the fourth embodiment of the present invention is the same in composition of the main component as the magnetic core 1 for a transformer according to the first embodiment and differs only in the shape.

As shown in FIG. 7A and FIG. 7B, the magnetic core 20 is a magnetic core of a so-called “pot shape” and is provided with a ring (outer leg) 22 and 23 formed integrally with the peripheral edges of a disk (bottom plate), cutaway parts 24, and a slug (center leg) 25 formed integrally at the peripheral edges of the disk 21.

Even with the magnetic core 20 for a transformer according to this embodiment, it is possible to make the THD of the transformer not more than −75 dB over a broad frequency band.

When using a transformer using a magnetic core 20 for a modem in ADSL or other high speed data communication, the distortion of the transmission waveform or noise in the transformer becomes small and occurrence of transmission error can be prevented, so data can be transmitted with a high accuracy.

Fifth Embodiment

As shown in FIG. 8, the magnetic core 30 for a transformer according to the fifth embodiment of the present invention is the same in composition of the main component as the magnetic core 1 for a transformer according to the first embodiment and differs only in the shape.

As shown in FIG. 8, the magnetic core 30 is a magnetic core of a so-called “EPC shape”, is integrally formed with a center leg 34 at the center in the X-direction of the bottom plate, and is integrally formed with an outer leg 32, 33 at the two sides.

Even with the magnetic core 30 for a transformer according to this embodiment, it is possible to make the THD of the transformer not more than −75 dB over a broad frequency band.

When using a transformer using a magnetic core 30 for a modem in ADSL or other high speed data communication, the distortion of the transmission waveform or noise in the transformer becomes small and occurrence of transmission error can be prevented, so data can be transmitted with a high accuracy.

Other Embodiments

Note that the present invention is not limited to the above embodiments and may be modified in various ways within the scope of the present invention.

For example, the shape of the magnetic core for a transformer is not limited to the above shape. It may also be an EE shape comprised of a combination of a pair of E-shaped magnetic cores, an EI shape comprised of a combination of an E-shaped magnetic core and I-shaped magnetic core, or other shape. Whatever the shape, it is possible to make the THD of the transformer not more than −75 dB in a broad frequency band.

Further, in the explanation of the embodiments, reference was made to ADSL, but the present invention is of course not limited to this. It may be broadly applied to VDSL or other XDSL as well.

Next, the present invention will be explained in further detail based on examples, but the present invention is not limited to these examples.

### EXAMPLES 1 TO 13 AND COMPARATIVE EXAMPLES 1 TO 6

As the starting materials of the main component, Fe₂O₃, Mn₃O₄, and ZnO were used. Further, as the sub components, at least two of the following were contained: SiO₂:30 to 180 ppm, CaCO₃: 100 to 2000 ppm, Nb₂O₅: 0 to 300 ppm, V₂O₅: 0 to 500 ppm, MoO₃: 0 to 400 ppm, ZrO: 0 to 300 ppm, Bi₂O₃: 0 to 800 ppm, SnO₂: 0 to 3500 ppm, and P: 0 to 100 ppm.

The starting materials were weighed so that the components became as shown in Table 1 after sintering. They were wet mixed, dried, then calcined in the atmosphere for 2 hours at 900° C.

The sub components were added to the obtained calcined material and mixed by pulverization. After mixing, a binder, that is, polyvinyl alcohol, was added, the result was granulated by a spray drier etc., then the EP shape shown in FIG. 1A and FIG. 1B was formed. The obtained shaped article was fired at 1400° C. in an atmosphere controlled in oxygen concentration to obtain an Mn—Zn-based ferrite sintered body.

Next, each of these Mn—Zn-based ferrite sintered bodies were used as magnetic cores for a transformer and measured for THD.

The evaluation conditions will be explained next. As the magnetic core, the magnetic core 1 of an EP shape as shown in FIG. 1 was used.

Two magnetic coils 1 were used. These were used in a state with the center leg 2 and the outer leg 3 overlaid respectively. At that time, the center leg 2 was inserted into bobbins around which the primary coil and secondary coil were wound. A gap of ΔG was provided at the center leg of the magnetic core in accordance with need to adjust the inductance to a suitable value.

To reduce the leakage inductance, the primary coil was divided into two to form a sandwich coil of a primary coil (70 turns)-secondary coil (140 turns)-primary coil (70 turns). This transformer was connected to an audio analyzer for measurement of the THD.

As an audio analyzer, a System 2 made by Audio Precision Co. was used. As shown in FIG. 2, the primary coil Np of the transformer was connected in series to a 10 Ω resistance and connected to the terminals t₁ and t₂. The secondary coil Ns was connected in parallel to a 50 Ω resistance and connected to the terminals t₃ and t₄. Note that since a 40 Ω resistance was connected in series to the generator side of the measuring instrument, a 50 Ω resistance was connected in series at the primary side of the transformer.

Data signals of frequencies of 5 kHz, 30 kHz, and 100 kHz were input to the primary coil Np of the transformer from the terminal t₁ and t₂ to give a voltage across the ends of the primary side of the transformer of 2.5V, while the transmission waveform output to the secondary coil Ns side was input to the terminals t₃ and t₄. The results were analyzed by the analyzer and the THD at 25° C. was measured. At that time, the loss of the magnetic core of the transformer in an AC magnetic field was also measured under the same conditions as THD measurement. The results of the measurement are shown in Table 1.

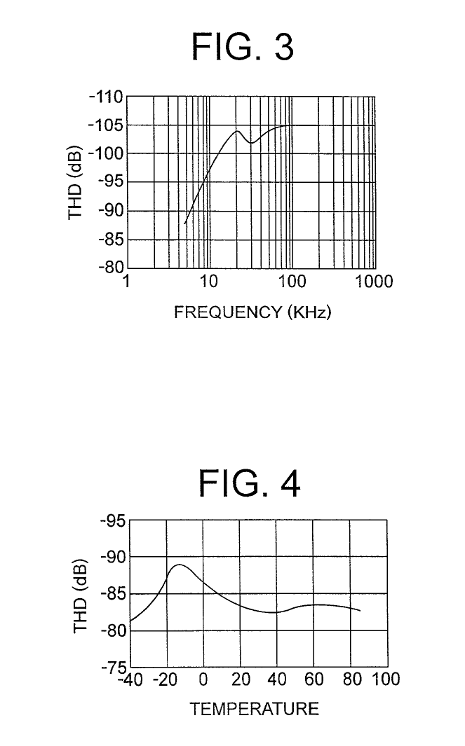

As the frequency characteristic of THD, as shown in FIG. 3, the THD at a high frequency is smaller in value and therefore more superior than the THD at a low frequency, so by measuring the value at 5 kHz, it is possible to judge the characteristic of a broad frequency band above that.

TABLE 1

| | | |
|---|---|---|
| | Magnetic | |
| Main component | core loss | THD (dB) |

| | composition (mol %) | | | (kW/m³) | | | 100 |
|---|---|---|---|---|---|---|---|
| | Fe₂O₃ | MnO | ZnO | (5 kHz) | 5 kHz | 30 kHz | kHz |
| Ex. 1 | 52.9 | 23.9 | 23.2 | 1.0 | −88 | −102 | −105 |
| Ex. 2 | 52.7 | 24.0 | 23.3 | 1.0 | −88 | −102 | −105 |
| Ex. 3 | 52.8 | 24.1 | 23.1 | 1.0 | −88 | −102 | −105 |
| Ex. 4 | 53.5 | 26.2 | 20.3 | 1.0 | −86 | −102 | −105 |
| Ex. 5 | 53.3 | 26.3 | 20.4 | 1.0 | −86 | −102 | −105 |
| Ex. 6 | 53.4 | 26.4 | 20.2 | 1.0 | −86 | −102 | −105 |
| Ex. 7 | 53.3 | 23.1 | 23.6 | 1.1 | −83 | −101 | −105 |
| Ex. 8 | 53.1 | 23.2 | 23.7 | 1.1 | −83 | −101 | −105 |
| Ex. 9 | 53.2 | 23.3 | 23.5 | 1.1 | −83 | −101 | −105 |
| Ex. 10 | 54.0 | 32.7 | 13.3 | 1.1 | −83 | −100 | −105 |
| Ex. 11 | 52.8 | 24.5 | 22.7 | 1.1 | −82 | −100 | −105 |
| Ex. 12 | 52.9 | 25.5 | 21.6 | 1.1 | −81 | −100 | −105 |
| Ex. 13 | 54.0 | 33.0 | 13.0 | 1.1 | −80 | −100 | −105 |
| Comp. | 53.4 | 35.4 | 11.2 | 1.4 | −73 | −98 | −104 |
| Ex. 1 | | | | | | | |
| Comp. | 54.0 | 35.2 | 10.8 | 1.4 | −73 | −98 | −104 |
| Ex. 2 | | | | | | | |
| Comp. | 53.6 | 36.2 | 10.2 | 1.4 | −73 | −98 | −104 |
| Ex. 3 | | | | | | | |
| Comp. | 54.1 | 36.6 | 9.3 | 1.4 | −73 | −98 | −104 |
| Ex. 4 | | | | | | | |
| Comp. | 54.5 | 37.0 | 8.5 | 1.4 | −73 | −98 | −104 |
| Ex. 5 | | | | | | | |
| Comp. | 54.0 | 37.5 | 8.5 | 1.4 | −73 | −98 | −104 |
| Ex. 6 | | | | | | | |

As shown in Table 1, the following becomes clear from a comparison of Examples 1 to 13 and Comparative Examples 1 to 6. That is, in the case of a magnetic core comprised of an Mn-Zn-based ferrite material having a main component containing MnO: 22.0 to 34.5 mol % (in particular 23 to 33 mol %), ZnO: 12.0 to 25.0 mol % (13 to 24 mol %), and the rest of substantially Fe₂O₃, it becomes clear that the loss in an AC magnetic field becomes small and as a result the THD of the transformer becomes a small value of not more than −80 dB in a broad frequency band.

Therefore, when performing ADSL or other high speed data communication by a modem including a ferrite magnetic core of this composition, the distortion of the transmission waveform or noise in the transformer becomes small and occurrence of transmission error can be prevented, so data can be transmitted with a high accuracy.

In Table 1 as well, referring to Examples 1 to 3, it was found that with a composition of MnO: 23.8 to 24.2 mol %, ZnO: 23.0 to 23.4 mol %, and Fe₂O₃: 52.6 to 53.0 mol %, the THD characteristic of the transformer becomes a particularly superior value of not more than −85 dB in a broad frequency band.

Further, referring to Examples 4 to 6, it was found that with a composition of MnO: 26.1 to 26.5 mol %, ZnO: 20.1 to 20.5 mol %, and Fe₂O₃: 53.2 to 53.6 mol %, the THD characteristic of the transformer becomes a particularly superior value of not more than −85 dB in a broad frequency band.

Further, referring to Examples 7 to 9, it was found that with a composition comprised of MnO: 23.0 to 23.4 mol %, ZnO: 23.4 to 23.8 mol %, and Fe₂O₃: 53.0 to 53.4 mol %, the THD becomes not more than −80 dB even at 5 kHz over a broad temperature range of −40 to +85° C. as shown in FIG. 4. Due to this, with a transformer having a transformer magnetic core of Examples 7 to 9, the THD characteristic of the transformer is superior in a broad frequency band and broad temperature range.

As shown in Comparative Examples 1 to 6 in Table 1, it was found that if the ratio of MnO becomes larger than 34.5 mol % or the ratio of ZnO becomes smaller than 12.0 mol % in the composition of the main component of the Mn—Zn-based ferrite material, the loss of the magnetic core material in an AC magnetic field becomes larger and the THD becomes higher.

Further, if the ratio of MnO becomes less than 22.0 mol % or the ratio of ZnO becomes larger than 25.0 mol %, it was confirmed that the Curie temperature of the material of the magnetic core falls to the region of the temperature of actual use and the properties as ferrite are lost.

Therefore, if outside the range of composition of the main component of MnO: 22.0 to 34.5 mol %, ZnO: 12.0 to 25.0 mol %, and the rest of substantially Fe₂O₃, when used as the magnetic core for a transformer used in a modem in ADSL or other high speed data communications, it is clear that transmission of data at a high accuracy is difficult.

### EXAMPLE 14

Except for using an EP shape of a through gap structure shown in FIG. 5A and FIG. 5B instead of the EP shape shown in FIG. 1A and FIG. 1B, the magnetic core was formed and tested in the same way as Examples 1 to 13. When the THD of the transformer was measured, it only became higher by about 2 dB compared with just a center gap shown in FIG. 1A and FIG. 1B. It became clear that even with a transformer of a through gap structure, the THD becomes a small value of not more than −75 dB in a broad frequency band.

What is claimed is:

1. A magnetic core composition for an xDSL modem transformer having a main component comprised of MnO: 22.0 to 34.5 mol % and ZnO: 12.0 to 25.0 mol % and the rest of substantially Fe₂O₃.

2. The magnetic core composition for an xDSL modem transformer as set forth in claim 1, having a main component comprised of MnO: 23 to 33 mol % and ZnO: 13 to 24 mol % and the rest of substantially Fe₂O₃.

3. The magnetic core composition for an xDSL modem transformer as set forth in claim 1, having a main component comprised of MnO: 23.8 to 24.2 mol %, ZnO: 23.0 to 23.4 mol %, and Fe₂O₃: 52.6 to 53.0 mol %.

4. The magnetic core composition for an xDSL modem transformer as set forth in claim 1, having a main component comprised of MnO: 26.1 to 26.5 mol %, ZnO: 20.1 to 20.5 mol %, and Fe₂O₃: 53.2 to 53.6 mol %.

5. The magnetic core composition for an xDSL modem transformer as set forth in claim 1, having a main component comprised of MnO: 23.0 to 23.4 mol %, ZnO: 23.4 to 23.8 mol %, and Fe₂O₃: 53.0 to 53.4 mol %.

6. A magnetic core for an xDSL modem transformer having a main component comprised of MnO: 22.0 to 34.5 mol % and ZnO: 12.0 to 25.0 mol % and the rest of substantially Fe₂O₃.

7. The magnetic core for an xDSL modem transformer as set forth in claim 6, having a main component comprised of MnO: 23 to 33 mol % and ZnO: 13 to 24 mol % and the rest of substantially Fe₂O₃.

8. The magnetic core for an xDSL modem transformer as set forth in claim 6, having a main component comprised of MnO: 23.8 to 24.2 mol %, ZnO: 23.0 to 23.4 mol %, and Fe₂O₃: 52.6 to 53.0 mol %.

9. The magnetic core for an xDSL modem transformer as set forth in claim 6, having a main component comprised of MnO: 26.1 to 26.5 mol %, ZnO: 20.1 to 20.5 mol %, and Fe2O3: 53.2 to 53.6 mol %.

10. The magnetic core for an xDSL modem transformer as set forth in claim 6, having a main component comprised of MnO: 23.0 to 23.4 mol %, ZnO: 23.4 to 23.8 mol %, and Fe₂O₃: 53.0 to 53.4 mol %.

11. A magnetic core for a transformer comprising
a bottom plate,
a columnar center leg rising from an approximate center of said bottom plate in a first direction, and
an outer leg rising from said bottom plate surrounding at least the two sides of the center leg in the first direction separated by a predetermined space,
a height of the center leg being lower than a height of said outer leg by exactly a predetermined gap and a through gap of substantially the same height as the height of the center leg being formed at part of the top of said outer leg.

12. The magnetic core for a transformer as set forth in claim 11, having a main component comprised of MnO: 22.0 to 34.5 mol % and ZnO: 12.0 to 25.0 mol % and the rest of substantially Fe₂O₃.
